(19) United States
(12) Patent Application Publication
(10) Pub. No.: US 2010/0083442 A1
(43) Pub. Date: Apr. 8, 2010

(54) COTS AND ATTACHMENTS FOR COTS FOR CARRYING PATIENTS OVER UNEVEN OR SLOPED TERRAIN

(76) Inventor: John E. Nash, Chester Springs, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/570,439

(22) Filed: Sep. 30, 2009

Related U.S. Application Data
(60) Provisional application No. 61/102,533, filed on Oct. 3, 2008.

(51) Int. Cl. A61G 1/02; A61G 1/013

(52) U.S. Cl. 5/620

(57) ABSTRACT

Ambulance cots and attachments for ambulance cots are disclosed. The cots include a frame having a base on which plural wheels are mounted. At least some of the wheels are arranged to be moved from a retracted position to an extended position to increase the track of the cot and thus improve its roll stability. The attachment is arranged to convert a conventional cot having a predetermined track into a cot whose track can be increased to enhance its roll stability.

### CROSS-REFERENCE TO RELATED APPLICATIONS

This utility application claims the benefit under 35 U.S.C. §119(e) of Provisional Application Ser. No. 61/102,533 filed on Oct. 3, 2008, entitled COTS AND ATTACHMENTS FOR COTS FOR CARRYING PATIENTS OVER UNEVEN OR SLOPED TERRAIN and whose entire disclosure is incorporated by reference herein.

STATEMENT REGARDING FEDERALLY SPONSORED RESEARCH OR DEVELOPMENT

“Not Applicable”

### INCORPORATION-BY-REFERENCE OF MATERIAL SUBMITTED ON A COMPACT DISK

“Not Applicable”

### FIELD OF THE INVENTION

This invention relates generally to patient transport devices, and more particularly to cots and attachments for cots to enable a patient to be safely transported over uneven or sloped terrain.

### BACKGROUND OF THE INVENTION

Cots are used to transport patients within hospitals, to move patients from hospitals to ambulances, and to carry the patient within an ambulance. A large variety of designs have been produced that cater to the differing needs of the situations encountered. For example, mobile cots of fixed height can function adequately in hospitals, but folding cots are required for transportation in ambulances. Adjustable height cots are useful for retrieving a prone patient, for moving the patient safely at a low height over rough terrain, and then for moving the patient to an ambulance at a greater height. In addition cots have more recently been designed for obese patients weighing as much as 500 pounds or more. Some of these cots have now included electrical/hydraulic power operation to allow the raising and lowering of the patient with minimal operator lift contribution. Examples of modern cots having telescopic frames and electro/hydraulic lifting mechanisms are shown in U.S. Pat. Nos. 7,398,571 (Souke et al.), and 7,389,552 (Reed et al.) and in EMS Equipment Catalog, #2343376: Ferno Inc., 70 Weil Way, Wilmington, Ohio 45177 and EMS Equipment Catalog, Mkt Lit-170-22 January 2007 Rev A: Stryker Inc., 3800 E. Centre Avenue, Portage, Mich. 49002.

In particular, U.S. Pat. No. 7,398,571 (Souke et al.) discloses an ambulance cot having a base frame configured for support on a surface, a litter frame configured for supporting thereon a patient and an elevating mechanism interconnecting the base frame and the litter frame and configured to interconnect the litter frame and the base frame in order to facilitate movement of the base frame and the litter frame toward and away from each other. A control mechanism is provided on the cot which is configured to facilitate the movement of the base frame and the litter frame toward each other and at differing speeds predicated on at least one of whether the base frame is supported on the surface and the litter frame is supported by an external support separate from the elevating mechanism.

U.S. Pat. No. 7,389,552 (Reed et al.) discloses ambulance cots, cot systems and methods of using the same. The ambulance cot includes a hydraulic system and a tip angle monitoring, recording and alert system, and methods of using the same (e.g., to transport subjects and/or to detect and/or record operational data related to cot usage).

As will be appreciated by those skilled in the art, as patients get heavier and broader there is the risk of the cot toppling sideways on uneven surfaces or on side slopes, such as are encountered on sidewalks and cambered roads. There is therefore a need for a cot that exhibits enhanced roll stability on such surface.

The present invention addresses that need by providing cots and attachments for cots that incorporates adjustable track width on at least one set of load carrying wheels to improve the roll stability.

All references cited and/or identified herein are specifically incorporated by reference herein.

### SUMMARY OF THE INVENTION

In accordance with one aspect of this invention an ambulance cot is provided for supporting a patient thereon. The ambulance cot comprises a frame having a base on which plural load carrying wheels are mounted. The plural load carrying wheels comprise at least one pair of wheels, with the wheels of the at least one pair of wheels being adapted to be moved from a retracted position to an extended position and vice versa. When the wheels are in the retracted position they are separated from each other by a minimum distance and when they are in the extended position they are separated from each other by a distance greater than that minimum distance to thereby increase the roll stability of the cot.

In accordance with another aspect of this invention an ambulance cot is provided for supporting a patient thereon. The ambulance cot comprises a frame having a longitudinal axis, a front pair of load carrying wheels and a rear pair of load carrying wheels. The wheels are separated from each other to establish a predetermined track for the cot. The cot additionally comprises means adapted for increasing the effect track of the cot in the event that either the front pair of load carrying wheels or the rear pair of load carrying wheels has left the ground as the cot starts to tip over.

In accordance with still another aspect of this invention an ambulance cot is provided for supporting a patient thereon. The ambulance cot comprises a frame having a longitudinal axis, a front pair of load carrying wheels, a rear pair of load carrying wheels, and a pair of pilot wheels. The wheels of the front pair and the wheels of the rear pair are separated from each other to establish a predetermined track for the cot. The pilot wheels are adapted to be deployed laterally with respect to the longitudinal axis of the cot to improve the roll stability of the cot.

In accordance with yet another aspect of this invention an attachment for an ambulance cot is provided. The ambulance cot is arranged for supporting a patient thereon and comprises a frame on which plural load carrying wheels are mounted. The plural load carrying wheels are spaced apart by a fixed distance to establish a predetermined track for the cot. The attachment comprises at least one pair of auxiliary wheels mounted on a structure that is releasably securable to the frame of the cot. The auxiliary wheels provide an increase in the track of the cot to improve the roll stability of the cot.

### DESCRIPTION OF THE DRAWING

FIG. 1 is a side elevation view of a conventional (prior art) ambulance cot with cruciform support legs in their raised position;

FIG. 2 is a view similar to FIG. 1 but showing the cot with its cruciform support legs in their collapsed position;

FIG. 3 is an end view of the cot shown in FIG. 1 bearing an obese patient, showing center of gravity of cot and patient, and showing the cot's “tipping angle”;

FIG. 4 is a graph showing tipping angles for various wheel extensions from the standard “track” of a cot;

FIG. 5 is an isometric view of an ambulance cot constructed in accordance with one embodiment of this invention, with the bottom of the cot including a pair of stabilizing lateral swing arms and with the cruciform support legs and the patient bearing support (mattress) of cot being shown by phantom lines;

FIG. 6 is an isometric view, similar to FIG. 5, but showing another alternative embodiment of this invention, namely, a cot having two pair of stabilizing lateral swing arms, one pair being located at the front of the cot and the other at the rear of the cot;

FIG. 7 is an enlarged isometric view of the bottom portion of the cot of FIGS. 5 and 6, showing the deployment mechanism used for deploying the stabilizing lateral swing arms;

FIG. 8 is an isometric view similar to FIG. 5, but showing still another alternative embodiment of this invention, namely, a cot having two pair of telescopic axle beams, one pair at the front of the cot, and the other pair at the rear of the cot;

FIG. 9 is an isometric view similar to FIG. 5, but showing yet another alternative embodiment of this invention, namely, a cot having a pair of lateral swing arms deploying auxiliary pilot wheels mounted on the cot's base frame;

FIG. 10 is an enlarged isometric view of the bottom portion of the cot of FIG. 8, showing the deployment mechanism used for deploying the pair of telescopic axle beams; and

FIG. 11 is a side view, partially in section of an auxiliary device constructed in accordance with another aspect of this invention including a removable frame carrying a pair of lateral swing arms bearing respective pilot wheels for ready mounting on the base of a conventional cot to convert that cot into one that exhibits an increased width track.

### DETAILED DESCRIPTION OF THE PREFERRED EMBODIMENT

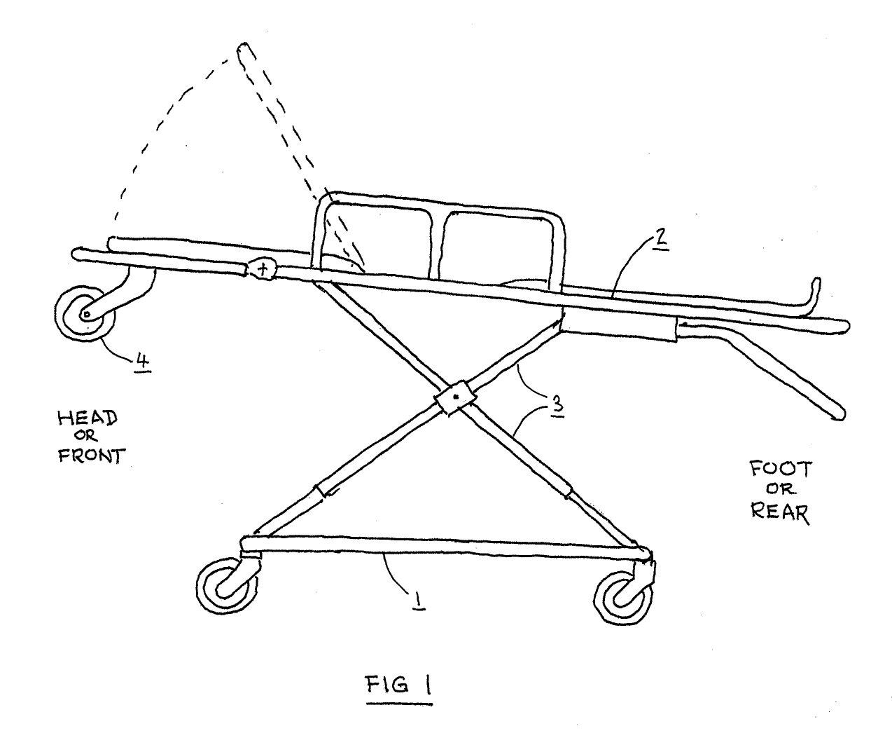

Referring now to the various figures of the drawing wherein like reference characters refer to like parts, there is shown in FIGS. 1-3 conventional or prior art, ambulance cots which exhibit the drawback described above, i.e., the susceptibility to be tipped over due to their somewhat narrow track. In order to increase the roll stability of an ambulance cot significantly it is necessary to increase the track of the load carrying wheels. In most applications the maximum cot height is dictated by two situations, transfer of a patient onto the ambulance cot from a hospital bed, or when the cot is transferred to an ambulance. Consequently, increases in track need to be a significant proportion of the height of the center of gravity of the patient/cot combination in these situations. With the subject invention it is envisaged that this increase in track of the cot would be used transiently to cross a particularly uneven piece of ground and the track would be brought back to the normal value when the cot has to be placed in an ambulance or taken through a dwelling or hospital

To increase the cot wheel track several systems constructed in accordance with are presented herein and will now be described. Some make use of swing arms on which are mounted the regular casters for load carrying, the swing arms moving in the horizontal plane, others make use of extendable or telescoping arms. The regular load carrying caster axle beams can be telescopic, with the caster pivot points being moved apart laterally on telescopic slides. An additional set of pilot wheels can be mounted on swing arms that move out laterally from the cot's base frame/chassis. Such an arrangement can be incorporated as an add-on improvement (i.e., an attachment) to a standard cot. Any of these embodiments of this invention could incorporate activation by manual application of a force onto a foot operated treadle or by a hand operated crank. Electrical or hydraulic power or stored compressed gas could be used in addition to aid in operating these mechanisms.

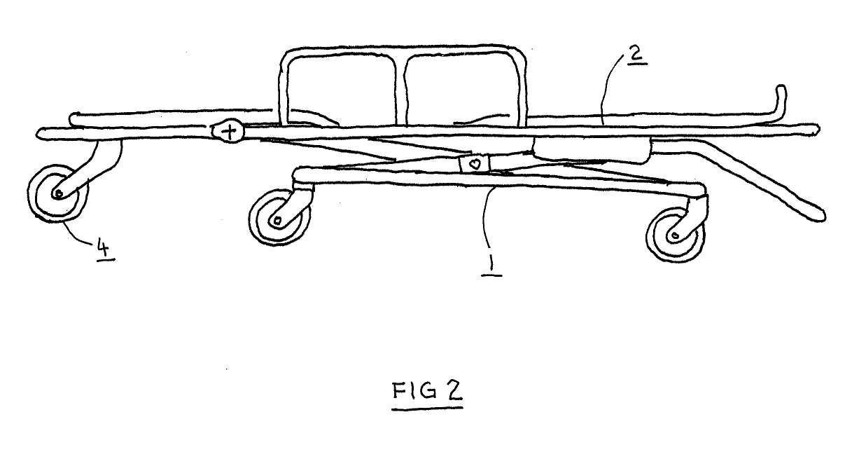

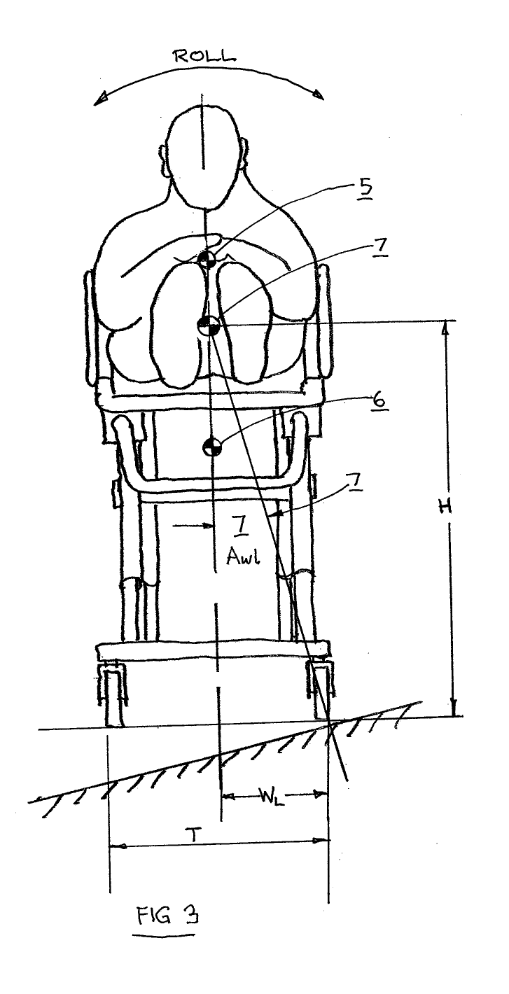

In order to clarify terminology, the left-hand end of the cot shown in FIG. 1 will be called the head or front, and the right-hand end the foot or rear, and the concept of roll is noted in FIG. 3. Referring to FIG. 1, there is shown a typical ambulance cot in the raised position with cruciform collapsing configuration having a base platform with wheels 1 and a patient carrying litter frame 2, the two items being connected with a collapsible telescopic cruciform linkage 3. Such a telescopic collapsible frame is shown in the aforementioned Souke et al. patent. FIG. 2 shows the same cot in the collapsed configuration. As can be seen in both figures a pair of pilot wheels 4 is located at the front end of the base of the cot. The wheels 4 are used to permit loading of the cot into an ambulance by transferring the front load onto the ambulance floor prior to collapsing the linkage 3. The pilot wheels are not relevant to the issue of roll stability. Rather, they are shown because they are part of virtually all ambulance cots.

FIG. 3 shows an end view of an ambulance cot with an obese patient in place on the mattress or pad of the cot. The patient's center of gravity (COG) is designated by the reference number 5, and cot's COG is designated by the reference number 6. The combined COG of cot and patient is designated by the reference number 7 in FIG. 3 and the angle at which the cot will tip over (called the tipping angle or Aw1) is also shown. FIG. 3 is basically drawn to scale. As can be seen therein the tipping angle Awl is quite small, so that it is quite easy to encounter this sort of angle on cambered or sloped surfaces, thereby subjecting the patient to the risk of being tipped over on the cot when traversing uneven or sloped terrain. If, however, the half-track of the cot is increased, the tipping angle Awl also increases. In FIG. 3 the half track is shown as W1 and represents the half-track for casters with locked wheels, that is the casters are in alignment with the longitudinal axis of the cot.

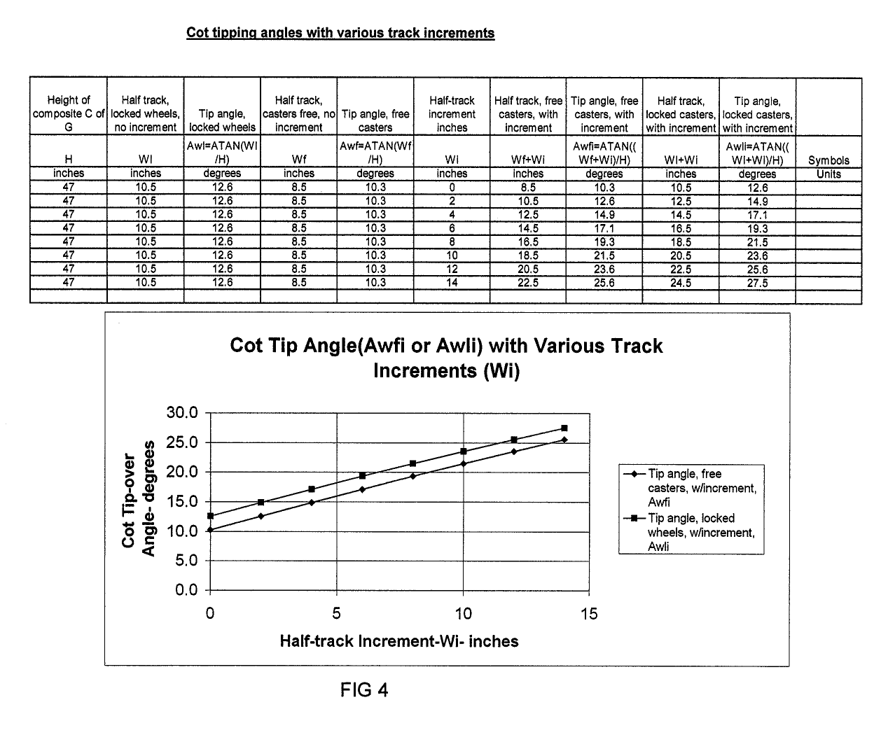

FIG. 4 shows the values for tipping angle for different values of half track W1 for the patient and cot shown in FIG. 3, and also shows values for varying half track Wf with casters free to pivot. As will be appreciated by those skilled in the art these two values are different because the tendency is for the casters to pivot inwards toward the cot's center line once tipping is about to occur, and since the caster trail is typically 2 inches for 6 inch wheels the effective half track is reduced by 2 inches, thus making the tipping more likely. Thus, from FIG. 4 it can be seen that the tipping angle Awf for pivoting casters can be changed from 10 degrees with no track increase Awf to over 20 degrees with track increments Awfi of 8-10 inches. The figures in the chart of FIG. 4 are based on the fact that typical tracks ‘T’ like that of conventional ambulance cots, such shown in FIG. 3, are 22 inches, this being determined by the width of the passageways available to cots in hospitals and ambulances and constraints imposed by cornering the cots in narrow corridors.

As should be appreciated from the foregoing an increase in the cot's half-track can go a long way to reduce the risk of the cot tipping over on rough or sloped terrain. The embodiments of this invention that will now be described achieve that end and thus enhance patient security. All of the following embodiments exhibit a standard wheel track for placement of the cot in an ambulance and for navigation around medical buildings or normal homes, yet have the ability to exhibit a wider track when necessary, e.g., when on sloped or uneven terrain.

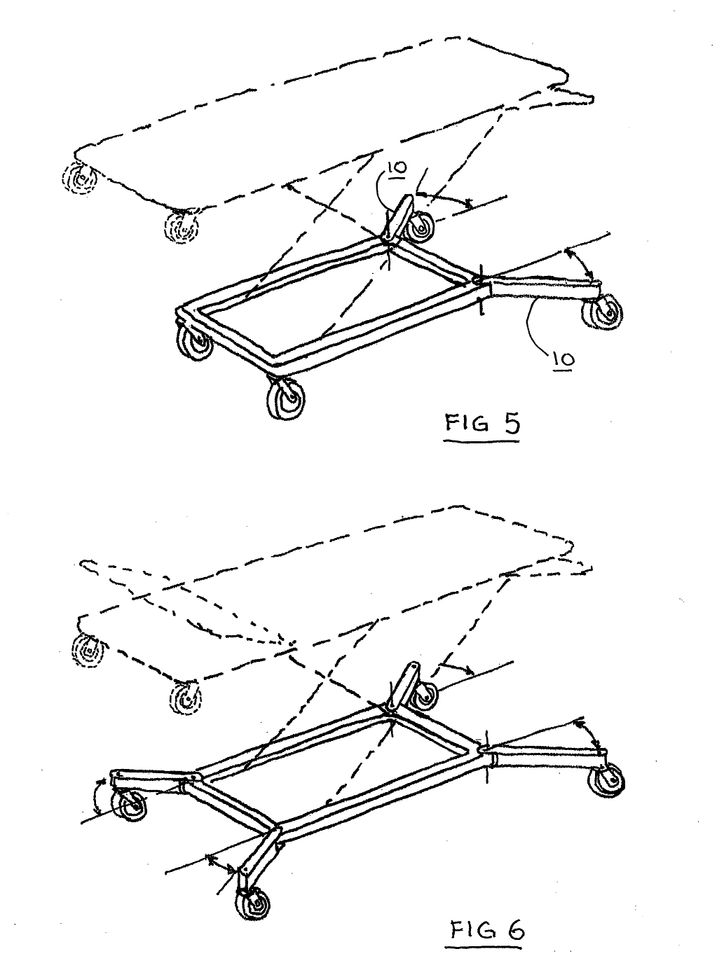

For example, FIG. 5 shows one exemplary embodiment of an ambulance cot constructed in accordance with this invention including a pair of swing arms 10 that increase the track at the rear of the cot only. Each of those arms includes a main load-carrying caster or wheel 10A mounted at the distal or free end thereof. Clearly if the track is only increased at one end of the cot it will not be as effective as if the track is increased at both ends, but this arrangement may be adequate for many situations. In FIG. 6 an alternative embodiment is shown wherein the swing arms 10 are located at both ends of the cot, i.e., at the front end and at the rear end, with each swing arm including a caster or wheel 10A at its distal or free end.

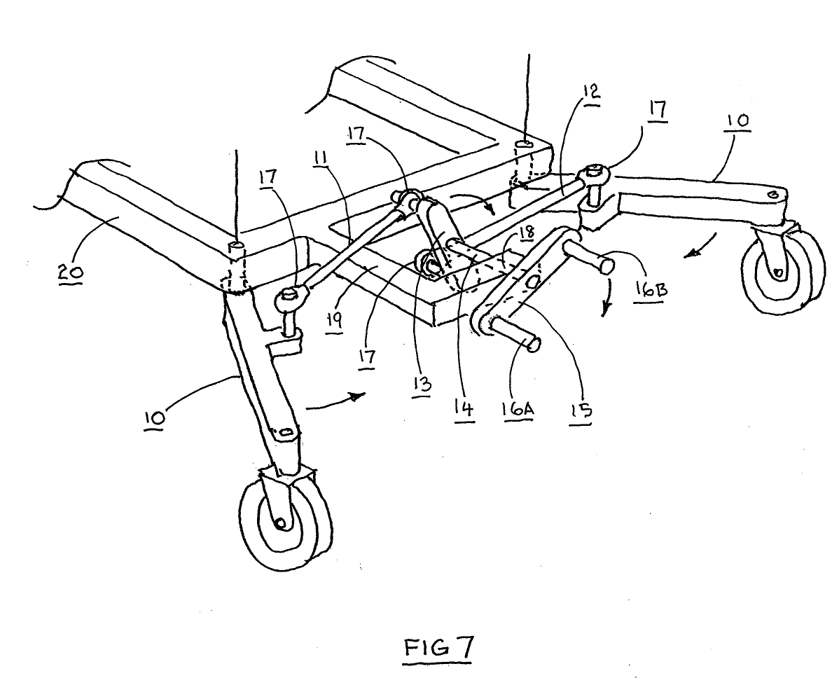

FIG. 7 illustrates one exemplary mechanical means, e.g., a foot treadle, for operating the swing arms, i.e., extending them to increase the track of the cot or retracting them so that the cot can be used when navigating smaller passageways. In particular, the swing arms 10 are linked to a plate 13 through links 11 and 12 and ball joints 17. A plate 13 is mounted on a shaft 14 which runs in bearing 18 mounted on a bracket 19 which is in turn fastened to the frame 20 of the cot. The shaft 14 has a crank plate 15 secured to the right hand end. The crank plate 15 has two treadle rods 16A and 16B mounted thereon. To operate the swing arms 10 to increase width of the track of the cot, all that the operator has to do is to apply a force to the treadle 16A, which in turn revolves the shaft 14 counter clockwise. This in turn moves links 11 and 12 outward, which action has the effect of urging the swing arms outward in the increasing track direction. Application of force on treadle 16B causes the swing arms to move backward, thereby reducing the track.

As should be appreciated by those skilled in the art stops and detents could be added to the cot to enable selection of specific track increments. Moreover, the activation of the swing arms can be accomplished by electrical power, e.g., using electric motors cams gears and the like. Alternatively, power to effect the movement of the swing arms can be provided from stored compressed gas cylinders operating through pistons and linkages, or hydraulic jacks drawing power from electric pumps, or hydraulic accumulators could be used. Fundamentally, the swing arms could be operated by any mechanical hydraulic or pneumatic means commonly known in the art.

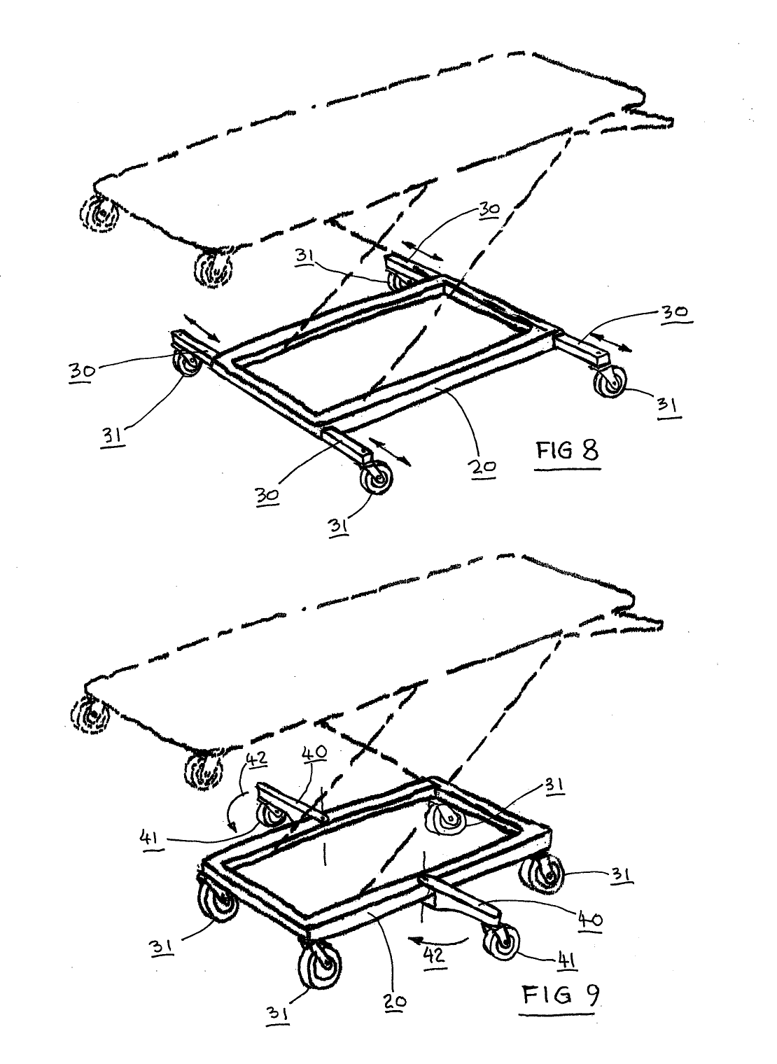

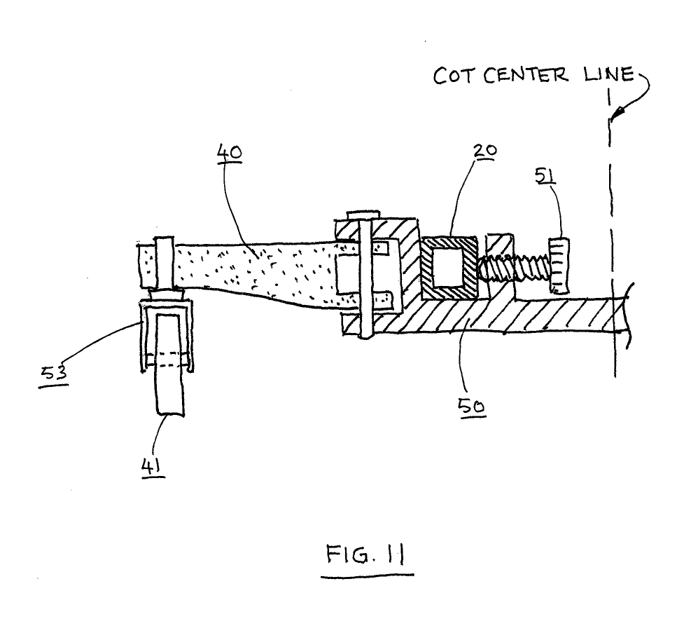

FIG. 8 depicts an alternative embodiment of this invention. In that embodiment a pair of extendable/contractable telescopic axle beams 30 are provided in the base portion of the frame of the cot. The cot's main load carrying casters 31 are mounted on respective ones of the telescopic axle beams at the free end thereof. The extension and contraction of the telescopic beams can be achieved by a linkage operated by a treadle (to be described hereinafter with reference to FIG. 10) or by a screw jack, or by a hydraulic or pneumatic cylinder or by an electric motor (not shown) or any other common means known in the art. Thus, in FIG. 10 there is shown a treadle arrangement for driving the telescopic axle beams 30 from regular (contracted) track position to greater track (extended) and vice versa. The axle beams 30, on which the load carrying wheels 31 are mounted, telescope into the cot's frame 20. A slot 32 is provided in the end of the frame 20 and locates pins 33 which are fastened to the axle beams 30. The pins 33 in turn are linked to a plate 13 through links 11 and 12 and ball joints 17. The plate 13 is mounted on a shaft 14 which runs in bearing 18 that is mounted on a bracket 19. The bracket 19 is in turn fastened to the cot's frame 20. A shaft 14 has a crank plate 15 secured to the right hand end. The crank plate 15 has two treadle rods 16A and 16B mounted thereon. To operate the axle beams 30 in the direction of increasing the cot's track all that the operator has to do is to apply a force on the treadle 16A which in turn revolves shaft 14 counter clockwise. That action, in turn moves the links 11 and 12 outward, thus urging the axle beams in the increasing track direction. Application of force on treadle 16B causes the axle beams to retract back into the frame, thereby reducing the track.

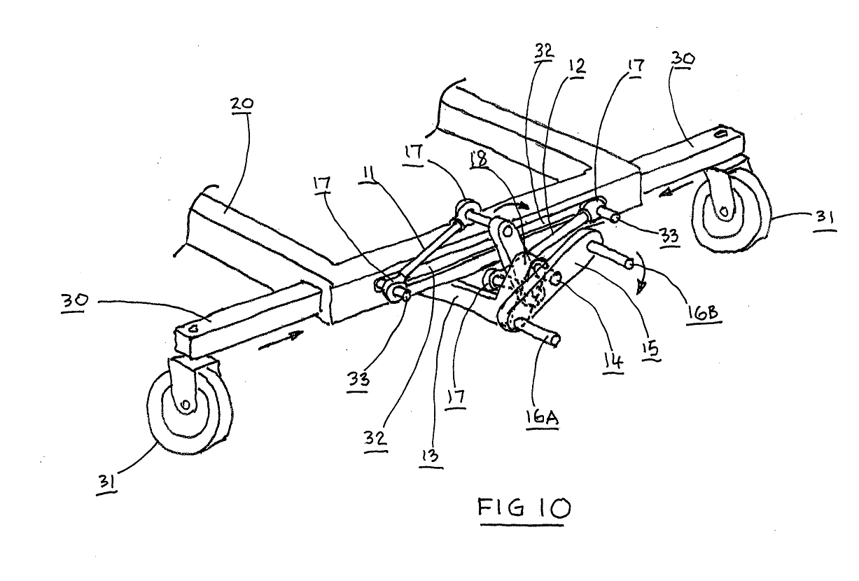

FIG. 9 illustrates a further embodiment of a means of improving roll stability for a cot, which by its nature can be added as an attachment to an existing cot at modest cost. To that end, the embodiment of the attachment shown therein basically comprises a pair of auxiliary pilot wheels 41 are mounted on respective arms 40. The arms 40 are arranged to be pivotably mounted on the cot's base, so that when retracted they can be parked alongside the cot base 20 by moving them in the direction of arrows 42. To increase the stability of the cot the arms 40 can be swung outward, so that or the arms 40 are oriented to provide the broadest track as shown in FIG. 9. Suitable locking detents, pawls or stops (not shown) can be used to lock the arms 40 in suitable operating positions. In use, the operator would use the cot with the arms 40 parked alongside the frame 20 when in a hospital or ambulance, but would move the arms 40 to the broadest track position (the position shown in FIG. 9) when navigating undulating, sloping or rough surfaces. The arms 40 are shown at the midpoint of the frame 20 in FIG. 9, but could be at any point on the frame length that might offer an appropriate mounting point.

Another manner for improving stability of a cot is contemplated in accordance with another aspect of this invention. For example, an additional set of stabilizing pilot wheels can be mounted on swing arms mounted to the cot sub-frame. In this arrangement the cot is moved along with the load carried on the normal four load carrying wheels, with the pilot wheels positioned a little clear of the floor. These pilot wheels only function to keep the cot erect in the event of the cot starting to veer away from vertical. The arms carrying the pilot wheels can be moved into position by the operator at will using linkages (like shown in FIG. 11) or by powered screws or other means known in the art.

FIG. 11 is a partial sectional view showing one half of another embodiment of this invention, which embodiment constitutes a variation of the embodiment of FIG. 9. In particular, this alternative embodiment consists of an attachment in the form of a removable cross-beam on which a pair of swing arms is mounted. Each swing arm includes a pilot wheel 41 at its free end. In FIG. 11 only one half of the attachment is shown. That attachment comprises a removable cross-beam and wheel set about the cot's longitudinal centerline. In this case the auxiliary pilot wheels 41 are mounted on casters 53 and swing arms 40 that are in turn mounted on the removable cross-beam 50. The cross-beam 50 is arranged to be releasably mounted, i.e., clamped, to the cot's frame 20 with screw clamps 51. In this embodiment the stabilizing wheels 41 and the beam 50 are removable and thus can be used on any cot. Alternatively, the attachment could be removed for storage. In the case of the auxiliary pilot wheels 41 shown in FIGS. 9 and 11 the wheels 41 can be of different diameter from the main load carrying wheels 31. Moreover, the wheels 41 need not have their load carrying points (the bottom of the wheel surface) in the same plane as the load carrying plane. For example, the cot may be permitted to tip a small amount before the auxiliary wheels provide a corrective moment. Such an arrangement would reduce the drag of the auxiliary wheels 41 on rough ground unless a tipping point was encountered.

Without further elaboration the foregoing will so fully illustrate my invention that others may, by applying current or future knowledge, adopt the same for use under various conditions of service.

I claim:

1. An ambulance cot for supporting a patient thereon and comprising a frame having a base on which plural load carrying wheels are mounted, said plural load carrying wheels comprising at least one pair of wheels, said wheels of said at least one pair of wheels being adapted to be moved from a retracted position to an extended position and vice versa, said wheels when in said retracted position being separated from each other by a minimum distance and when in said extended position being separated from each other by a distance greater than said minimum distance, whereupon when said at least one pair of wheels is in said extended position the roll stability of said cot is increased.

2. The ambulance cot of claim 1 wherein each of said wheels of said at least one pair of wheels is mounted on an elongated member.

3. The ambulance cot of claim 2 wherein said elongated member is pivotable mounted to said base of said frame.

4. The ambulance cot of claim 2 wherein said elongated member is telescopically mounted to said base of said frame.

5. The ambulance cot of claim 3 additionally comprising mechanical means for pivoting said elongated members from said retracted position to said extended position and vice versa.

6. The ambulance cot of claim 5 wherein said mechanical means is operated by a source of power.

7. The ambulance cot of claim 5 wherein said mechanical means is manually operated.

8. The ambulance cot of claim 4 additionally comprising mechanical means for telescoping said elongated members from said retracted position to said extended position and vice versa.

9. The ambulance cot of claim 8 wherein said mechanical means is operated by a source of power.

10. The ambulance cot of claim 8 wherein said mechanical means is manually operated.

11. An ambulance cot for supporting a patient thereon and comprising a frame having a longitudinal axis, a pair of load carrying wheels on one side of said longitudinal axis and a pair of load carrying wheels on the opposite side of said longitudinal axis, said pairs of wheels being separated from each other to establish a predetermined track for said cot, said cot additionally comprising means adapted for increasing the effect track of said cot in the event that either said pairs of load carrying wheels has left the ground as the cot begins to tip over.

12. An ambulance cot for supporting a patient thereon and comprising a frame having a longitudinal axis, a front pair of load carrying wheels, a rear pair of load carrying wheels, and a pair of pilot wheels, said wheels of said front pair and said rear pair being separated from each other to establish a predetermined track for said cot, said pilot wheels being adapted to be deployed laterally with respect to said longitudinal axis to improve the roll stability of said cot.

13. The ambulance cot of claim 12 wherein said pilot wheels are mounted so that they do not engage the surface on which the load carrying wheels of the cot are located when that surface is flat and level.

14. An attachment for use on an ambulance cot for supporting a patient thereon, the ambulance cot comprising a frame having a base on which plural load carrying wheels are mounted, said plural load carrying wheels being spaced apart by a fixed distance to establish a predetermined track for the cot, said attachment comprising at least one pair of auxiliary wheels mounted on a structure, said structure being releasably securable to the frame of the cot, said auxiliary wheels providing an increase in the track of the cot to improve the roll stability of the cot.

15. The attachment of claim 14 wherein each of said auxiliary wheels is mounted so that it can be moved from a retracted position to an extended position and vice versa, said auxiliary wheels when in said extended position being separated from each other by a distance greater than the distance separating the load carrying wheels to thereby provide an increase in the track of the cot to improve the roll stability of the cot.
